(19) United States
(12) Patent Application Publication
(10) Pub. No.: US 2015/0294069 A1
(43) Pub. Date: Oct. 15, 2015

(54) MULTI-SOURCE PATIENT GENERATED HEALTHCARE DATA INTEGRATION IN A TRANSACTIONAL SYSTEM

(71) Applicant: Shahid N. Shah, Silver Spring, MD (US)

(72) Inventor: Shahid N. Shah, Silver Spring, MD (US)

(73) Assignee: Netspective Communications LLC, Silver Spring, MD (US)

(21) Appl. No.: 14/686,684

(22) Filed: Apr. 14, 2015

Related U.S. Application Data
(60) Provisional application No. 61/979,020, filed on Apr. 14, 2014.

(51) Int. Cl. G06F 19/00; G06Q 30/00

(52) U.S. Cl. CPC G06F 19/322; G06Q 30/018

(57) ABSTRACT

A system and method for aggregating patient generated healthcare data associated with a patient from a plurality of computing machines located separately without patient intervention. Metadata is stored associated with the patient generated healthcare data in a medical record repository database to perform natural language processing and metadata analysis of the patient generated healthcare data to identify patient verified data and patient unverified data. A data object including query statements and approval options is generated and presented on a remotely located display unit accessible by the patient. An input against each of the plurality of query statements is received and the system provides updating of the unverified data based on the received input. The patient generated healthcare data is then pushed into the electronic medical transactional system which may communicate medical data messages among a plurality of computer stations.

### CROSS-REFERENCE TO RELATED APPLICATIONS

This application claims the benefit of U.S. Provisional Application No. 61/979,020, filed on Apr. 14, 2014 and entitled “Multi-Source Patient Generated Data Collection System and Method,” the complete disclosure of which, in its entirety, is hereby incorporated by reference.

### BACKGROUND

1. Technical Field

The embodiments herein generally relate to medical data ingestion and management, and more particularly relate to collection of ‘patient generated healthcare data’ (PGHD) that is not entered directly by the patient and integration of the PGHD within a medical transactional system.

2. Description of the Related Art

PGHD or sometimes also referred to as ‘consumer generated healthcare data’ (CGHD) encompasses forms of data that patients generate or provide before it is submitted for entry into a medical transactional system. In some cases, the PGHD may be provided to the medical transactional system on behalf of a third party that may be a healthcare provider, a patient relative, or any other individual or firm. In some cases, the PGHD may be directly entered by or sourced from a patient. PGHD may, for example, include patient historical medical reports or records, diagnosis reports, biometric data, data gathered by medical devices associated with a patient, etc. PGHD may be huge in quantity and heterogeneous in nature and difficult to be managed into the workflow of the medical transactional system. Further, the PGHD may be collected from a plurality of diverse and heterogeneous sources. Generally, clinical decisions may be made based on the PGHD supplied by the patients themselves or through other parties and accumulated in the medical transactional system. Decision makers such as healthcare professionals or medical practitioners may not be sure of completeness, accuracy, trustworthiness, and reliability of this data. Either the healthcare professionals completely rely on it or completely disregard it due to concerns of reliability and validity based on the degree of complications associated with such a decision making by a practitioner. It is not known who is responsible for completeness or accuracy of such PGHD if the PGHD is not directly entered by the patient.

Further, incorporation of biometric or medical devices data into the medical transactional system makes the decision making and clinical workflow even more complex. The intensity of complexity may increase as there is an increase in the level of control of the medical devices by a patient. For example, data from a plurality of patient-associated medical devices such as for exercise management, diet management, weight management, etc. may make integration of the PGHD even more confusing and complex due to increased lack of reliability, trust, validity, and no clarity about the authority for responsibility of data completeness and accuracy in the medical transactional system. There is always a possibility that fake data may be entered by someone on behalf of a patient. The fake data may arrive from institutions or persons other than the patient. There have been cases where malware are uploaded through mobile devices or smart phones etc that access patient records repositories and submit fake data which corrupts the records in the medical transactional system leading to wrong decision making. Such and other issues may arise if the PGHD is not entered by the patient himself and the PGHD is gathered without patient awareness or with no control of patient over data flow even if the patient is aware of the data flow in the medical transactional system.

Existing methods and systems provide a controlled access by patients to medical transactional systems and allow entry of data by the patients themselves. U.S. Pat. No. 8,428,968 for example provides such a system and method wherein patients are allowed to enter data in an EMR themselves. The system, based on certain predefined physiology values, determines accuracy and validity of the patient-entered data. If the patient-entered data does not fit within the defined values, the patient is requested to confirm the patient-entered data. U.S. Pat. No. 8,428,968 focuses on data that is directly entered by the patient but does not teach solutions to reliability issues that arise when the data is not entered by the patient himself. U.S. Pat. No. 8,428,968 does not provide a system or method to allow ensuring data completeness and reliability of the PGHD that is not directly entered or sourced from the patient.

In light of the above, there is a need for an improved system and method for ensuring reliability, trust, accuracy, and completeness of the PGHD for integration in a medical transactional system, wherein the PGHD is derived from a variety of medical devices and patient data sources but not directly entered or sourced from the patient thereby causing a major concern for accuracy, reliability and completeness during integration with the medical transactional system.

### SUMMARY

An embodiment herein provides a system that includes a cloud gateway agent server to receive and aggregate patient generated healthcare data associated with a patient and acquired without patient intervention from a plurality of computing machines located separately. The patient generated healthcare data includes a plurality of computer executable patient data files residing in the plurality of computing machines. The system further includes a medical record repository database communicatively coupled with the cloud gateway agent server to store the plurality of computer executable patient data files and metadata associated with the plurality of computer executable patient data files. The system further includes a processing circuit to perform natural language processing and metadata analysis of the plurality of computer executable patient data files to identify patient verified computer executable patient data files and patient unverified computer executable patient data files from among the plurality of computer executable patient data files. The processing circuit generates a data object including a plurality of query statements and approval options corresponding to each of the unverified computer executable patient data files. The processing circuit transmits the data object to an external computing machine at the patient along with the unverified computer executable patient data files outputted on a remotely located display unit connected operatively with the external computing machine through an automatically generated notification by the processing circuit. The data object represents an integrated view of the patient generated healthcare data residing on the plurality of computing machines. The processing circuit updates the unverified computer executable patient data files as new verified computer executable patient data files in the medical record repository database based on an input received from the external computing machine signifying verification of the unverified computer executable patient data files by the patient. The system further includes a rules engine communicatively coupled with the processing circuit for executing a set of programmable rules including dictionary references, and patient verification references to govern patient approval, the metadata analysis and the natural language processing. The system further includes an electronic medical transactional system communicatively coupled with the medical record repository database and the processing circuit through the cloud gateway agent server to: retrieve and store the patient verified computer executable patient data files and the new verified computer executable patient data files from the medical records repository database; and communicate medical data messages among a plurality of computer stations located at patients, healthcare providers, and financial entities, wherein the medical data messages are obtained from the patient verified computer executable patient data files and the new verified computer executable patient data files. The system further includes a communications transmitter coupled with the electronic medical transactional system for transmitting the medical data messages to the plurality of computer stations identified by a patient approval.

An embodiment herein provides a computer-implemented method for use in the electronic medical transactional system. The method includes aggregating patient generated healthcare data associated with a patient from a plurality of computing machines located separately by a cloud gateway agent server over a network through a communication circuit without patient intervention. The patient generated healthcare data comprises a plurality of computer executable patient data files residing on the plurality of computing machines. The method further includes storing the plurality of computer executable patient data files in a medical record repository database communicatively coupled with the cloud gateway agent server. The method further includes storing metadata associated with the plurality of computer executable patient data files in the medical record repository database. The method further includes performing natural language processing and metadata analysis of the plurality of computer executable patient data files by a processing circuit communicatively coupled with the cloud gateway agent server to identify patient verified computer executable patient data files and patient unverified computer executable patient data files from among the plurality of computer executable patent data files. The method includes generating, by the processing circuit, a data object including a plurality of query statements and approval options corresponding to each of the unverified computer executable patient data files. The method further includes presenting the data object along with the unverified computer executable patient data files on a remotely located display unit accessible by the patient through an automatically generated notification by the processing circuit. The data object represents an integrated view of the patient generated healthcare data residing on the plurality of computing machines. The method includes receiving an input against each of the plurality of query statements corresponding to the unverified computer executable patient data files by the patient. The method includes updating the unverified computer executable patient data files as new verified computer executable patient data files in the medical records repository database based on the received input. The method includes pushing the verified computer executable patient data files and the new verified computer executable patient data files into the electronic medical transactional system. The method includes communicating, by the electronic medical transactional system, medical data messages among a plurality of computer stations located at patients, healthcare providers, and financial entities, wherein the medical data messages are obtained from the patient verified computer executable patient data files and the new verified computer executable patient data files based on a predefined patient approval associated with the medical data messages.

An embodiment herein provides a non-transitory program storage device readable by a computer, and comprising a program of instructions executable by the computer for use in an electronic medical transactional system to perform a method. The method includes aggregating patient generated healthcare data associated with a patient from a plurality of computing machines located separately by a cloud gateway agent server over a network through a communication circuit without patient intervention. The patient generated healthcare data comprises a plurality of computer executable patient data files residing on the plurality of computing machines. The method further includes storing the plurality of computer executable patient data files in a medical record repository database communicatively coupled with the cloud gateway agent server. The method further includes storing metadata associated with the plurality of computer executable patient data files in the medical record repository database. The method further includes performing natural language processing and metadata analysis of the plurality of computer executable patient data files by a processing circuit communicatively coupled with the cloud gateway agent server to identify patient verified computer executable patient data files and patient unverified computer executable patient data files from among the plurality of computer executable patent data files. The method includes generating, by the processing circuit, a data object including a plurality of query statements and approval options corresponding to each of the unverified computer executable patient data files. The method further includes presenting the data object along with the unverified computer executable patient data files on a remotely located display unit accessible by the patient through an automatically generated notification by the processing circuit. The data object represents an integrated view of the patient generated healthcare data residing on the plurality of computing machines. The method includes receiving an input against each of the plurality of query statements corresponding to the unverified computer executable patient data files by the patient. The method includes updating the unverified computer executable patient data files as new verified computer executable patient data files in the medical records repository database based on the received input. The method includes pushing the verified computer executable patient data files and the new verified computer executable patient data files into the electronic medical transactional system. The method includes communicating, by the electronic medical transactional system, medical data messages among a plurality of computer stations located at patients, healthcare providers, and financial entities, wherein the medical data messages are obtained from the patient verified computer executable patient data files and the new verified computer executable patient data files based on a predefined patient approval associated with the medical data messages.

### BRIEF DESCRIPTION OF THE DRAWINGS

The features of the disclosed embodiments may become apparent from the following detailed description taken in conjunction with the accompanying drawings showing illustrative embodiments herein, in which:

FIG. 1 illustrates an ecosystem including an electronic medical transactional system for integration of patient generated healthcare data (PGHD) in accordance with an embodiment herein;

FIG. 2 illustrates a method for integration of the PGHD in accordance with an embodiment herein;

FIG. 3 illustrates an exemplary electronic medical transactional system, in accordance with an embodiment herein;

FIGS. 4 and 5 illustrate exemplary user interfaces for allowing a patient to interact with a cloud gateway agent server for verification of the PGHD in accordance with the embodiments herein;

FIG. 6 illustrates generally, but not by the way of limitation, a computer system that may be used in accordance with the embodiments herein.

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

In the following detailed description, reference is made to the accompanying drawings which form a part hereof, and in which is shown by way of illustration specific embodiments in which the embodiments herein may be practiced. These embodiments, which are also referred to herein as “examples,” are described in sufficient detail to enable those skilled in the art to practice the embodiments herein, and it is to be understood that the embodiments may be combined, or that other embodiments may be utilized and that structural, logical, and electrical changes may be made without departing from the scope of the embodiments herein.

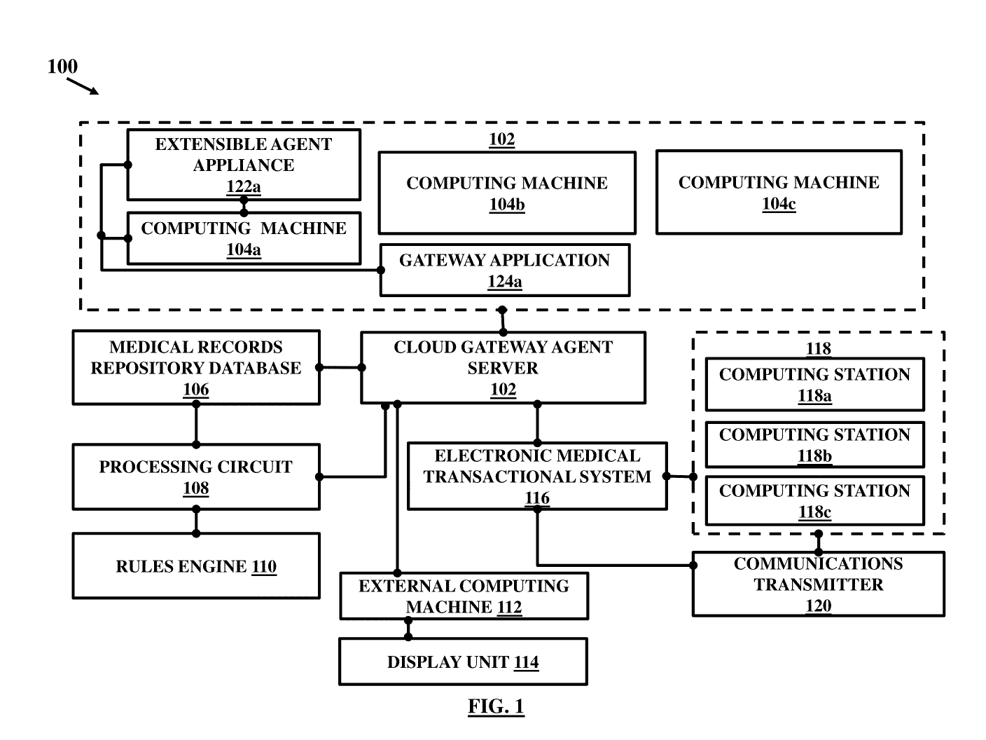

FIG. 1 illustrates an overview of ecosystem 100 for integration of Patient Generated Healthcare Data (PGHD) in an electronic medical transactional system. The ecosystem 100 includes a cloud gateway agent server 102 to receive and aggregate the PGHD associated with a patient from a variety of sources. The PGHD may reside on a plurality of computing machines 104a, 104b, and 104c together referred to as 104 located separately and remote from one another and remote from the cloud gateway agent server 102. The PGHD resides on the plurality of computing machines 104a-c in the form of a plurality of computer executable patient data files. For example, the PGHD in the computer executable patient data files can include two dimensional images, three-dimensional images, digital and/or analog images, and/or digital and/or analog video of a patient's organ or surrounding features. Also, text files can be generated, including notes, comments, prescription notes, and/or medical history.

A variety of data sources that may be coupled to the plurality of computing machines 104a-c or be included in the plurality of computing machines 104a-c or may serve as the plurality of computing machines 104a-c may include such as clinical systems, material management systems, clinical trial systems, consumer and patient health systems, managed care systems, telemedicine systems, physician data systems, core transaction systems, clinical data repositories, workflow systems, behavior data systems, decision support systems, patient relationship management systems, workforce enabling systems, imaging systems, electronic data capture systems, medical management systems, integrated medical devices, labs systems, clinical trials systems, patient family and community engagement systems, social patient relationship management systems, patient consent, permissions and disclosure management systems, patient communications systems, social networking platforms or social networking engines, and the like without limitations.

In accordance with some embodiments herein, the PGHD is aggregated without any patient intervention. In accordance with some embodiments, the PGHD is aggregated from the plurality of computing machines 104a-c with limited patient intervention. In an example, the plurality of computing machines 104a-c may be located remotely from the patient and the PGHD is aggregated from the plurality of computing machines 104a-c without any patient intervention such that the patient is not aware about or involved during receipt or access of the PGHD from the plurality of computing machines 104a-c or during generation of the PGHD from the patient by a computing machine such as the computing machine 104a or a healthcare service provider associated with the computing machine 104a. The plurality of computing machines 104a-c in such a case may be located at healthcare provider end in an example. For example, the patient may have submitted his medical data in various data sources at the healthcare provider or medical devices associated with the patient may have generated data which may be gathered and stored in a storage device at the healthcare provider without any patient intervention or control over data acquisition or without any awareness by the patient of data access and collection by the healthcare provider or without any control of review or verification of the PGHD by the patient even if he is aware of data generation and collection by the computing machine 104a. In accordance with some embodiments, the PGHD may refer to medical data generated from various medical devices or collected by the healthcare provider and stored with the healthcare provider without patient control or intervention. The PGHD as defined herein is not directly entered by the patient for submission with the cloud agent gateway server. The PGHD can be submitted by the patient to the computing machine 104a or the healthcare provider without any control over review and verification or confirmation of the PGHD. In accordance with some embodiments herein, the PGHD refers to data acquired from various sources coupled to or included within the plurality of computing machines 104a-c without any patient intervention in accordance with various data aggregating scenarios discussed hereafter without limitations.

In accordance with an embodiment herein, the computing machine 104a may be situated at a multiple healthcare setting in an acute care environment such that the patient whose PGHD is acquired through the computing machine 104a is unconscious. The patient is not in a state and has no capability of verifying the PGHD and any generation or acquisition of the PGHD may be considered without patient intervention. In an example, the computing machine 104a may be a medical device associated with the patient that generates or collects the PGHD (without any knowledge of the patient) for being acquired by the cloud gateway agent server 102. However, the patient is aware of the fact that he was present in the healthcare setting and therefore can review, verify, and/or authorize the PGHD later upon receipt of a request from the cloud gateway agent server 102.

In accordance with an embodiment, the computing machine 104a may be situated at a healthcare setting such that the patient is not unconscious but the care is provided by a healthcare provider. The patient does not have any choice or control over the PGHD being generated by the computing machine 104a situated at the healthcare provider or the healthcare setting. The patient can see the PGHD being generated by the computing machine 104a such as a medical device etc but the patient is incapable to monitor or review the PGHD being generated or captured. The patient is though aware of the data being generated and acquired to be pushed into the medical transactional system but has no control or choice over review and verification. In this scenario, the patient is not unconscious but still does not have any control to intervene and the PGHD so generated and acquired by the cloud gateway agent server 102 may be considered to be acquired without patient intervention.

In accordance with an embodiment, the healthcare provider may visit the patient and collect the PGHD thorough the computing machine 104a which can then transmit the PGHD to the cloud gateway agent server 102 for being pushed into a medical transactional system such as the medical transactional system 116 as will be discussed later. The patient is though aware of the generation and collection of the data by the healthcare provider or the computing machine 104a but has no control over verification of the PGHD. The PGHD so aggregated by the cloud gateway agent server 102 may not be verified for completeness or accuracy or ownership.

In accordance with another embodiment, the healthcare provider may provide a medical device to the patient that may include or be coupled to or serve as the computing machine 104a that generates and collects the PGHD from the patient. The patient may control and use the medical device but may have no control over data verification and review. The data may be erroneous. The PGHD so gathered by the medical device may be provided to the healthcare provider for further use in the electronic medical transactional system 116.

In accordance with another embodiment, the PGHD may be generated and collected by a wearable device that may be coupled to or may include or that may serve as the computing machine 104a and is capable of data exchange with the cloud gateway agent server 102. The wearable device generates data from the patient but the patient has no control with intervention over data editing, data review, data verification or authorization. The wearable device may transmit the PGHD to the cloud gateway agent server 102 upon notification of request without any patient intervention. The cloud gateway agent server 102 may not even know that the PGHD is acquired from the wearable device unless it is verified by the patient later, in an example.

In accordance with various embodiments, the patient may be aware, or not, about generation and collection of the PGHD by the computing machine 104a but the aggregation of the PGHD by the cloud gateway agent server 102 or/and the generation or collection of the PGHD by the computing machine 104a occurs without any patient intervention such that the patient has no control to verify, review and/or authorize the PGHD for sharing with other people. In some embodiments, even if the patient has some limited control of intervention and a portion of the aggregated PGHD is verified by the patient, entire PGHD associated with the patient may not be verified and/or reviewed by the patient. Hence, reliability of the entire PGHD is not high enough to trust unless it is verified by the patient in its entirety. There is always a possibility that some portion of the PGHD may be unverified.

In an example, the cloud gateway agent server 102 may host a series of server components and server applications such as agent admin server and agent admin applications, gateway monitor server and gateway monitor applications, processing circuits and other hardware and software components or modules or applications that act as a secure conduit between the cloud agent gateway server 102 and external cloud systems.

The ecosystem 100 further includes a medical record repository database 106 communicatively and operatively coupled with the cloud gateway agent server 102 to store the plurality of computer executable patient data files and metadata associated with the plurality of computer executable patient data files. The metadata associated with the plurality of computer executable patient data files may be indicative of details about the patient, such as name, age, gender, patient verification status, and the like.

The medical record repository database may include a row store, a column store, a file store, a graph store, and various other stores for storing the PGHD contained in the plurality of computer executable patient data files. The PGHD may include structured data, coded data, semi-structured data, unstructured data, scanned data, and the like. The medical record repository database 106 may include a database management system such as a relational database management system or of other type to handle large amounts of data obtained from the plurality of computing machines 104a-c. In an example, the computer executable patient data files stream through the cloud gateway agent server 102 as and when such files are received from the plurality of computing machines 104a-c. In another example, the computer executable patient data files may be received on-demand by the cloud gateway agent server 102 from the plurality of computing machines 104a-c and accordingly pushed into the medical records repository database 106. In accordance with this example, a data flow management circuit may be coupled with the medical records repository database 106 and the cloud gateway agent server 102 to control flow of the computer executable patient data files from the plurality of computing machines 104a-c on-demand by the cloud gateway agent server 102.

The ecosystem 100 further includes a processing circuit or a processor 108 coupled communicatively and operatively with the cloud gateway agent server 102 and the medical records repository database 106. The processing circuit 108 is configured to perform natural language processing and metadata analysis of the plurality of computer executable patient data files to identify patient verified computer executable patient data files and patient unverified computer executable patient data files from among the plurality of computer executable patient data files aggregated from the plurality of computing machines 104a-c. The processor 108 may include or be coupled communicatively and operatively with a rules engine 110. The rules engine 110 may be configured to execute a set of programmable rules including dictionary references, and patient verification references to govern patient approval of the computer executable patient data files, metadata analysis and natural language processing. The rules engine 110 may store the dictionary references for allowing the processing circuit 108 to perform semantic analysis, metadata analysis and natural language processing. The patient verification references may contain rules regarding patient approval for different types of medical data which in association with a metadata analysis output and a natural language processing output of the computer executable patient data files results in determination of and classification among the patient verified computer executable patient data files and the patient unverified computer executable patient data files (referred to interchangeably hereafter as verified computer executable patient data files and unverified computer executable patient data files without limitations).

The embodiments herein may employ natural language processing to identify the patient verified computer executable data file and the patient unverified computer executable patient data files, a set of specific terms may be defined. The processing circuit 108 may look for specific terms to identify the verified and unverified computer executable patient data files or patient verified and unverified PGHD. The PGHD, in an embodiment, may be stored as an unstructured component such as embedded in a note. The note may, for example, include physiological lab-oriented data of the patient that the patient could never verify. In an example, the note may read that the patient's fever at a defined healthcare setting measured 99 degree Celsius. The note may be stored as a natural text, in an example. The processing circuit 110 may employ the natural language processing on the physiological data embedded in the note to extract the specific terms such as terms related to ‘physiological’ etc. and data collection terms such as ‘patient’ from the natural text that might have been recorded by the healthcare provider as a patient record. If the note reads, for example, that the patient met the healthcare provider and verified the data collected by the healthcare provider from the note, the processing circuit 108 may associate high reliability score to the PGHD and consider it as verified PGHD.

In an example, the PGHD may be obtained from a medical record of the healthcare provider such that verification status by the patient may be maintained in the medical record by the healthcare provider. For example, the note from the healthcare provider may read that the PGHD was verified or not by the patient when he was conscious after surgery or the medical record may be silent about verification by the patient so that the PGHD may be classified by the processing circuit 108 as verified or unverified based on what the note says. In another embodiment, the PGHD may be obtained from the medical record of the healthcare provider but irrespective of the verification status of the patient mentioned in the note, the processing circuit 108 may look for a patient-driven separate patient verification status from the patient. The patient-driven verification may be obtained even if the healthcare provider medical record in the form of the note reads that the PGHD is verified by the patient in such cases.

In an embodiment the processing circuit 108 may perform natural language processing to discover new verification patterns across the PGHD based on old verification patterns. For example, if the processing circuit 108 finds six different patient notes from different healthcare providers in which the term ‘patient’ is mentioned wherein the PGHD contained in each of the six notes is mentioned to be verified by the patient, the processing circuit 108 may utilize machine learning algorithms to determine new verification patterns based on the old verification patterns and automatically verify the PGHD and increase its reliability considering that it looked similar to what the patient had already verified in accordance with the old verification patterns.

The processing circuit 108 is further configured to generate a data object including a plurality of query statements and approval options corresponding to each of the unverified computer executable patient data files as identified from the metadata analysis, and natural language processing by the processing circuit. The query statements may define a set of questions for seeking a patient approval for the unverified computer executable patient data files such that a response for the query statements by the patient may be represented through one of the approval options thereby verifying or dispute the patient generated healthcare data contained in the unverified computer executable patient data files. The data object may represent an integrated view of the patient generated healthcare data or the unverified computer executable patient data files residing on the plurality of computing machines 104a-c. The processing circuit 108 transmits the data object to an external computing machine 112 associated with the patient along with the unverified computer executable patient data files. The data object may be outputted on a remotely located display unit 114 connected operatively with the external computing machine 112. In an example, display of the data object may be activated through an automatically generated notification by the processing circuit 108 which may be received by the external computing machine 112.

The verification of the PGHD confirms belonging and ownership of the PGHD contained in the computer executable patient data files or the unverified computer executable patient data files represented through the data object. The approval options may be indicative of verifying the PGHD contained in the unverified computer executable patient data files as belonging to the patient or not belonging to the patient which signifies whether the PGHD collected from sources other than from the patient (such as healthcare provider) truly belongs to the patient and is trustworthy and reliable or does not belong to the patient and is not trustworthy and reliable. This is more important to verify because the PGHD is not directly entered by the patient but received from sources other than the patient or even if collected from medical devices associated with the patient, the patient does not have any control to review or verify the PGHD. Even if the PGHD is acquired from associated medical devices, the aggregation and retrieval of the PGHD is done without any patient intervention and is purely relied on the trustworthiness of the healthcare provider from where the PGHD is aggregated or relied on the accuracy and reliability of medical devices connections unless the PGHD is verified by the patient himself as is discussed herein. Based on a reply option from the patient in response to each of the query statements for each of the unverified computer executable patient data files, a patient input may be received by the cloud agent gateway server 102. The patient input may signify reliability and trustworthiness of the unverified computer executable patient data files and the PGHD contained therein.

The processing circuit 108 updates the unverified computer executable patient data files as new verified computer executable patient data files in the medical record repository database 106 based on the input received from the external computing machine 112 signifying verification of the unverified computer executable patient data files by the patient. The new verified computer executable patient data files may include data elements that may be identified as accurate and belonging to the patient as indicated by the patient input, or may include data elements that may be identified as inaccurate and not belonging to the patient as indicated by the patient input or a combination both. Even if the data elements are not accurate or complete which may represent that all or a portion of the PGHD does not belong to the patient and is wrongly attributed to the patient or is incomplete, the PGHD or a portion thereof is still considered as verified but wrong or incomplete data. The processor or processing circuit 108 may store the unverified computer executable patient data files as the new verified computer executable patient data files in the medical record repository database with a first indicator if the input is indicative of the patient generated healthcare data contained in the unverified computer executable patient data files to be reliable and belonging or rightly attributed to the patient. The processing circuit 108 may store the unverified computer executable patient data files as the new verified computer executable patient data files in the medical record repository database 106 with a second indicator if the input is indicative of the PGHD contained in the unverified computer executable patient data files to be non-reliable and not belonging to the patient and wrongly attributed to the patient. The processing circuit 108 may also store the first indicator and the second indicator along with the new verified computer executable patient data files such that the first indicator and the second indicator can facilitate in categorization of verified and unverified data and reliable or non-reliable PGHD in future once more patient generated healthcare data comes in and gets aggregated by the cloud gateway agent server 102 in the medical record repository database 106.

In an example, the PGHD residing in the form of the plurality of computer executable patient data files is aggregated by the cloud gateway agent server 102 from sources located at healthcare service provider for example such as with a physician, nursing home, medical doctor, hospital, and the like. In an example, the patient generated healthcare data may be aggregated from medical devices associated with the patient such as wearable medical devices serving as the plurality of computing machines 104a-c. The patient generated healthcare data can in such cases be obtained directly from the wearable medical devices or healthcare machines networked through a network with the cloud gateway agent server 102 and capable of data exchange and associated with the patient in a healthcare premise such as the hospital, nursing home, or any other healthcare service provider premise or even at patient home. Since the PGHD is not directly entered by the patient himself, there remains a possibility of non-reliability, inaccuracy, incompleteness of the data and therefore verification of the PGHD is performed by the cloud gateway agent server 102 and associated devices as discussed above and later to verify by the patient himself whether the data belongs to the patient and is rightly and completely attributed to him. Further, since in a hospital or any other healthcare service provider premise, several patients are admitted and there may be a possibility of errors and data exchange among different patients, it becomes extremely important to verify the PGHD so as to reliably use the PGHD through various medical transactional systems for data exchange for a variety of purposes. One such transactional system 116 is discussed hereafter. In accordance with an exemplary embodiment, it must be understood that the PGHD for use by the electronic medical transactional system 116 is obtained from the healthcare provider directly or from the medical devices associated with the patient at healthcare provider so as to ensure the PGHD is properly interpreted by the healthcare provider also for technical details and verified by the healthcare provider also and is ready for use by several other entities through the electronic medical transactional system 116. In accordance with an exemplary embodiment, the plurality of computing machines 104a-c from where the PGHD is aggregated reside at the healthcare provider and the PGHD is expert driven that is verified by the healthcare provider. In an example, the PGHD is not entered by the patient or sourced from the patient as it may lead to inaccuracy due to weak understanding or lack of expert understanding of technical details of the PGHD by the patient.

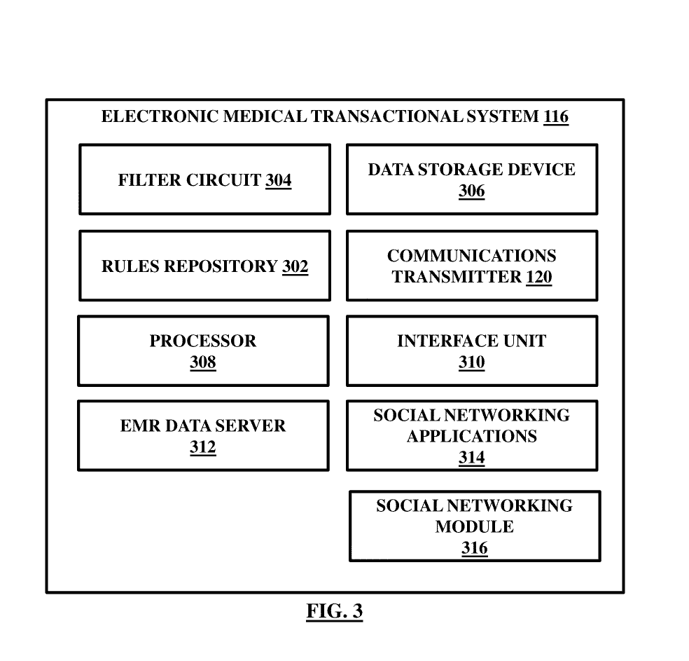

The ecosystem 100 may include the electronic medical transactional system 116 which may be communicatively coupled with the medical record repository database 106 and the processing circuit 108 through the cloud gateway agent server 102. The electronic medical transactional system 116 is configured to retrieve the patient verified computer executable patient data files and the new verified computer executable patient data files from the medical records repository database 106 and store them in a separate data storage device such as the data storage device 306 as shown in FIG. 3 that may be included within the electronic medical transactional system 116 or may be operatively and communicatively coupled with the electronic medical transactional system 116. The electronic medical transactional system 116 may be accessible by a plurality of computing stations 118a, 118b, and 118c together referred to as 118 located at patients, healthcare providers, and financial entities or other entities that may access the PGHD at least in part in accordance with patient approval guidelines for access defined by the electronic medical transactional system 116. The electronic medical transactional system 116 may be coupled operatively with or may include a communications transmitter 120 for transmitting medical data messages to the plurality of computing stations 118 identified by a patient approval. The medical data messages may include information requested by the plurality of computing stations 118 and derived from the verified computer executable patient data files and the new verified computer executable patient data files. It must be appreciated that the cloud gateway agent server 102 executes patient verification of the plurality of computer executable patient files so by the patient as to ensure that the various entities are allowed to access verified PGHD from the electronic medical transactional system 116. In an example, the embodiments herein therefore provide a mechanism for using by the entities reliable and trusted patient-verified PGHD that is already aggregated from expert driven sources such as healthcare provider or through automated devices such as wearables etc. The PGHD thus used by the entities for a variety of complex medical purposes is not only well interpreted by experts or health providers but also verified for completeness and patient ownership by the patient himself before integration with the electronic medical transactional system 116. This ensures that the PGHD is trustworthy enough and is also interpreted correctly.

In accordance with an embodiment herein, each of the plurality of computing machines 104a-c is coupled operatively and communicatively to an extensible agent appliance such as the computing machine 104a is coupled to an extensible agent appliance 122a. In an example, the extensible agent appliance 122a may be configured to host a plug and play cloud agent. The plug and play agent may consist of a central host such that various functionalities are added to it as separate plug-ins. New plug-ins as received from the cloud gateway agent server 102 may be automatically added into the plug and play agent. The plug and play agent can be installed by a user associated with the computing machine 104a or may be installed by the cloud agent gateway server 102. The extensible agent appliance 122a is capable of launching a gateway application 124a configured to pair a connected computing machine 104a with the cloud gateway agent server 102 to allow access of computer executable patient data files residing on the computing machine 104a by the cloud agent server 102. The gateway application 124a allows and automates transfer of the computer executable patient data files from the computing machine 104a to the cloud agent gateway server 102. In an example, a similar extensible agent appliance may be associated with the external computing machine 112 associated with the patient for verification of the PGHD. A similar gateway application may be launched at the external computing machine 112 for use by the patient to receive the unverified computer executable patient data files from the cloud agent gateway server 102 for verification. The gateway application at the external computing machine 112 may allow the patient to view the unverified computer executable patient data files, sources of the unverified computer executable patient data files and to verify the unverified computer executable patient data files through a single-click user executable response against one of the approval options. For example, the patient may simply mark ‘YES’ or ‘NO’ as one of the two approval options against the question statements in an embodiment. In this example, ‘YES’ may for example indicate that the unverified computer executable patient data files belong to the patient and ‘NO’ may indicate that the unverified computer executable patient data files do not belong to the patient. Any attribution of these files marked as ‘NO’ to the patient is to be considered wrong.

In accordance with various embodiments, the patient may be provided with an option or mechanism to verify the PGHD generated from the patient either through medical devices or wearables or by healthcare providers and aggregated without patient intervention by the cloud gateway agent server 102. The patient may also be provided with an option to authorize collection of the PGHD and/or authorization for others to view the PGHD.

In an embodiment herein such that the computing machine 104a is or includes or is coupled to a wearable device, the patient may give initial pre-authorization to collect the PGHD by the wearable device. In an example, the mere use of the wearable device by the patient may be considered as pre-authorization to collect the PGHD by the wearable device or the associated computing machine 104a. The patient may also give pre-authorization to share the PGHD to others or to some specific persons or entities or institutions. The patient may however not always have control over review, editing, completing or verification of the PGHD. There are possibilities that the PGHD so aggregated from the wearable device or the attached computing machine by the cloud gateway agent server 102 may not be reviewed or verified by the patient.

In an embodiment herein such that the patient is unconscious in a healthcare setting, the patient may not be capable to authorize collection of the PGHD by the computing machine 104a. The patient cannot even review, verify or complete the PGHD. The PGHD so aggregated by the cloud gateway agent server 102 and unverified by the patient is not reliable.

In accordance with an embodiment where the patient may be conscious and is aware of collection of the PGHD by a medical device or a healthcare provider but does not have control over review and verification of the PGHD, the patient may provide pre-authorization of collection of the PGHD because the PGHD is collected in front of the user. The patient may also confirm sharing of the PGHD to other persons. In some cases, the patient may not have control over review and verification of the PGHD. However upon request from the cloud gateway agent server 102 for verification, the patient may verify that the PGHD is correct and rightly attributed to him or not because he was present in the healthcare setting when the PGHD was collected.

In some examples, the PGHD may be collected in a digital format from medical devices such that the patient is admitted in an acute care setting. The patient has typically no control over data review and verification in the acute care environment and the files aggregated from the computing machines without patient intervention may contain data that is not verified by the patient himself.

In an embodiment, a healthcare provider may use his predefined equipment on the patient so that the PGHD collected by the healthcare provider through his device is not verified by the patient himself. The patient only authorizes the healthcare provider to use his equipment. The patient may not intervene during supply of the PGHD to the cloud gateway agent server 102 and the PGHD may remain unverified which is checked by the cloud gateway agent server 102 during aggregation of the PGHD as discussed earlier.

In accordance with some embodiments, though the patient may have control of pre-authorization to collect data by a healthcare provider or a medical device and the like and may also pre-authorize or de-assign sharing of the PGHD to others, it is possible, however, that the patient may not always have control to review and verify the PGHD before it is aggregated to the electronic medical transactional system 116 or to the cloud gateway agent server 102. There remains a possibility that the PGHD stored in the form of computer executable patient data files and aggregated by the cloud gateway agent server 102 may contain unverified data also. The unverified data may cause a wrong decision making by others using the PGHD through the electronic medical transactional system 116.

Further, in some embodiments, the PGHD may be collected by devices of a healthcare provider and in some other cases the PGHD may be collected from the patient by devices owned by the patient himself. These devices may be connected to the plurality of machines 104a-c which is networked to the cloud gateway agent server 102. There is always a high risk of the PGHD not verified by the patient when the devices are not owned by the patient. In case the PGHD collected from the patient is wrong, the patient or the associated external computing machine 112 may respond to the query statements through one of the reply options that the PGHD is wrong. For example, the patient may say that the temperature record is not 99 degree Celsius as mentioned. The patient may even be allowed to correct the PGHD.

The PGHD that is verified by the healthcare provider only comprises a low reliability data with a low score associated with it. If the PGHD is verified by the patient himself, the score rises very high and the PGHD may be considered as high reliability data.

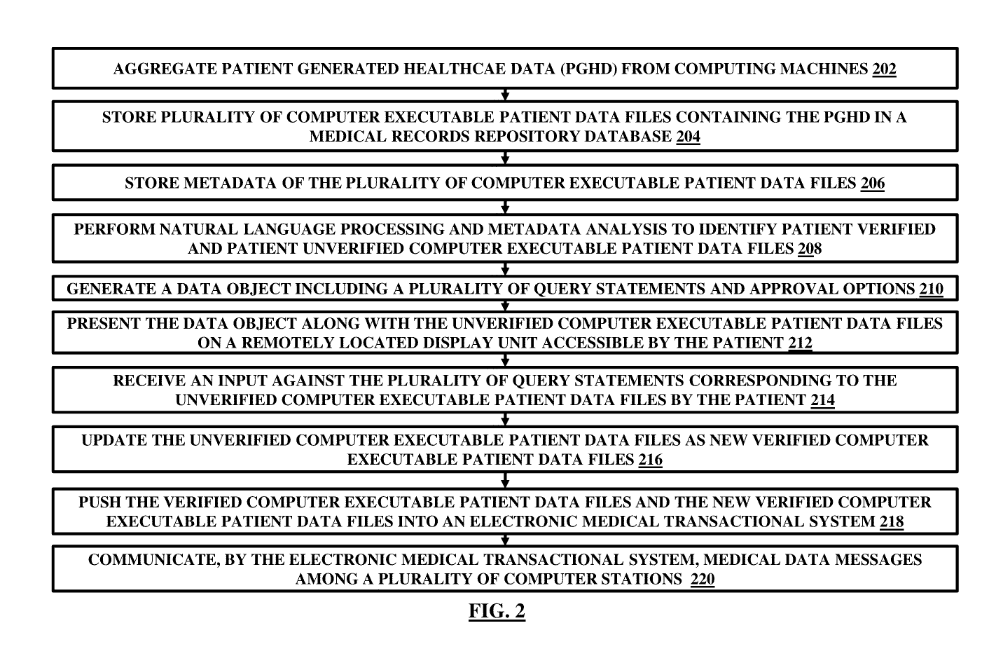

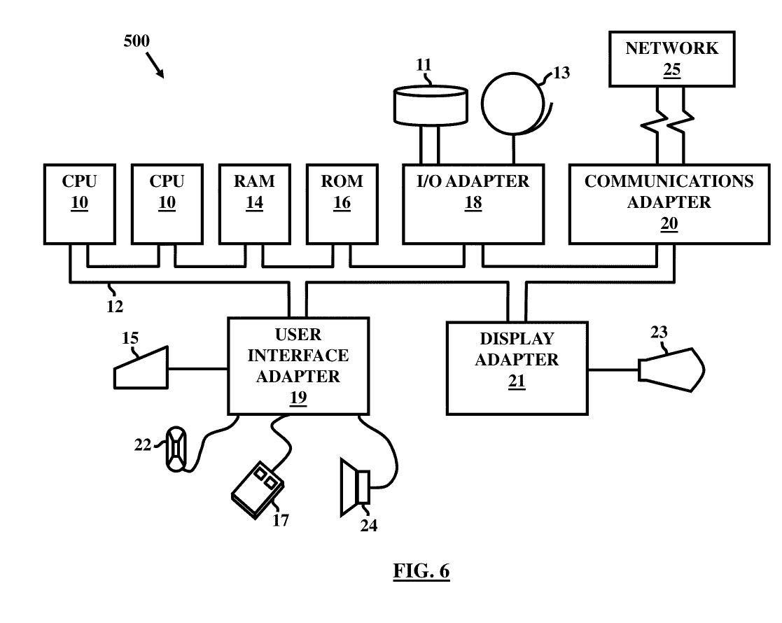

FIG. 2, with reference to FIG. 1, illustrates a method flowchart for integration of Patient Generated Healthcare Data (PGHD) aggregated from the plurality of computing machines 104a-c at healthcare provider or at other places in the electronic medical transactional system 116. The method may be implemented with the use of a computer system (such as system 500 of FIG. 6). At step 202, the method includes aggregating the PGHD associated with the patient from the plurality of computing machines 104a-c that may be located separately from one another and remote from the cloud gateway agent server 102. The PGHD is aggregated by the cloud agent gateway server 102 from the plurality of computing machines 104a-c over a network through a communication circuit without patient intervention such that the PGHD contained in the computer executable patient data files aggregated from the computing machines 104a-c is not entered by or sourced from the patient directly. The patient is not authorized to enter the PGHD so as to ensure reliability of the PGHD for technical interpretation. Instead, the PGHD is aggregated from the plurality of computing machines 104a-c located at for example healthcare provider as discussed above or aggregated from medical devices or wearables and the PGHD is later routed to the patient for verification upon identification of the unverified computer executable patient data files as discussed herein.

At step 204, the method includes storing the plurality of computer executable patient data files in the medical record repository database 106 communicatively coupled with the cloud gateway agent server 102. At step 206, the method includes storing the metadata associated with the plurality of computer executable patient data files in the medical record repository database 106.

At step 208, the method includes performing natural language processing and metadata analysis of the plurality of computer executable patient data files by the processing circuit 108 that is communicatively coupled with the cloud gateway agent server 102 to identify patient verified computer executable patient data files and patient unverified computer executable patient data files from among the plurality of computer executable patent data files. At step 210, the method includes generating, by the processing circuit 108, the data object including the plurality of query statements and approval options corresponding to each of the unverified computer executable patient data files.

At step 212, the data object is presented along with the unverified computer executable patient data files on the remotely located display unit 114 that is accessible by the patient upon receipt of an automatically generated notification by the processing circuit 108. The data object may represent an integrated view of the PGHD residing on the plurality of computing machines 104a-c. In an example, the data object may represent an integrated view of a portion of the PGHD contained in the unverified computer executable patient data files.

At step 214, the cloud agent gateway server 102 receives an input against each of the plurality of query statements corresponding to the unverified computer executable patient data files by the patient. The patient input may signify reliability and trustworthiness of the unverified computer executable patient data files and the PGHD contained therein and is indicative of whether the PGHD contained in the unverified computer executable patient data files belongs to the patient or not, is correctly attributed to the patient or not, is complete or not. A step 216, the unverified computer executable patient data files are updated as new verified computer executable patient data files in the medical records repository database 106 based on the received input. In an example, only those verified computer executable files are updated in the medical records repository database 106 for which the patient verifies the PGHD as correctly attributed to the patient and/or is complete. In an example, each of the unverified computer executable patient data files may be updated with indicators indicative of which portion of the PGHD is verified by the patient as complete, correctly attributed and which portion is incomplete and/or wrongly attributed to the patient.

In an example, after receiving patient verification or dispute or missing data, the medical records repository database 106 may update the verification or dispute or the missing data with confirmation or verification flags or indicators or such as verified, unverified, complete, incomplete, and the like. In an example, the external computing machine 112 can supply natural text as comments on top of the flags or indicators for example approved with comments, disapproved with explanation, and the like. If the source of the PGHD is known, a message may be sent to the source to make corrections and updates accordingly.

At step 218, the verified computer executable patient data files and the new verified computer executable patient data files are pushed into the electronic medical transactional system 116. At step 220, the electronic medical transactional system 116 may communicate medical data messages containing information retrieved from the patient verified computer executable patient data files and the new verified computer executable patient data files among the plurality of computer stations 118 located at patients, healthcare providers, and financial entities. The medical data messages may be communicated only after it is authorized by patients who own data contained in the medical data messages to share the data with one or more of the plurality of computer stations 118.

In an example, the PGHD may be derived from a plurality of sources such as the plurality of computing machines 104a-c including such as without limitations a plurality of patient-driven or patient associated medical devices at a hospital or at a healthcare provider. The devices may, for example, include devices to track exercise routines, diet management systems, fitness trackers, weight tracking devices, etc., without limitations. The devices may also include, for example, wearables (e.g., wearable devices).

The PGHD may be stored in a PGHD repository associated with each of the plurality of computing machines 104a-c from where the PGHD may be collected by the cloud agent gateway server 102.

In an example, the electronic medical transactional system 116 may include an electronic record of patient information that can be created, gathered, managed, and consulted by authorized clinicians or other healthcare professionals and staff of a specific healthcare provider that creates the record. The electronic medical transactional system 116 may also house an electronic record of patient information that conforms to nationally recognized interoperability standards and that can be created, managed, and consulted by authorized clinicians and staff of the healthcare provider that creates the record as well as those at other healthcare provider sites. Accordingly, the electronic medical transactional system 1116 may be aimed at an efficient management of multiple records in a single healthcare provider's practice, and integrating multiple data sources into each electronic record.

The electronic medical transactional system 116 may house a complete medical history of many patients collected from a variety of healthcare sources including healthcare professionals or staff at hospitals, clinics, and laboratories communicating through standard networks. The electronic medical transactional system 116 may also include biographical information about the patient describing the patient, including but not limited to the patient's age, gender, height and weight, and medical history information including the patient's medical conditions, previous medical procedures, medications, and laboratory test results. The electronic medical transactional system 116 may also integrate medical devices data that are representative of the patient's health routines and diagnostics, etc. The electronic medical transactional system 116 may be centrally accessed by many different healthcare sources and thus serves as a path of intercommunication among many individuals and machines working together to deliver healthcare.

The embodiments herein may allow aggregating of the PGHD from a plurality of sources including patient-driven or patient associated medical devices so as to integrate medical devices data into the electronic medical transactional system 116. In some embodiments, a portion of the aggregated PGHD may be already approved by a patient or a healthcare professional while another portion of the PGHD may not be approved by either a patient or a healthcare professional. In such cases, it is important to recognize the portion of the PGHD that is not approved by either of the patient or the healthcare professional. The embodiments herein may allow applying metadata analysis and natural language processing to evaluate the portion of the PGHD that is not approved and requires an approval. The PGHD aggregated from the plurality of sources or the plurality of computing machines 104a-c may include diverse and heterogeneous formats and types.

The PGHD may be homogenized by the processing circuit 108. The process of homogenization may include standardizing the heterogeneous and diverse PGHD so as to define it in compliance with a standard format or type as prescribed by the electronic medical transactional system 116 before its integration. The processing circuit 108 may be configured to homogenize the PGHD contained in the computer executable patient data files in a defined Health Insurance Portability and Accountability Act (HIPAA) compliant format. The embodiments herein may allow harmonizing and categorizing data that needs approval based on the evaluation. The process of harmonization and categorization identifies which portion of the PGHD needs approval from a patient and which portion of the PGHD needs approval from which healthcare professional. In an example, the embodiments herein may further allow processing of a patient approval, wherein an approval is requested from the patient associated with the PGHD. The patient approval may signify one or more of accuracy of the PGHD, reliability of the PGHD, completeness of the PGHD, and defines a person responsible for accuracy and completeness of the PGHD who may be either the patient himself, a relative of the patient, a healthcare professional, or any other person or firm. In some embodiments, the patient may be a child or any other person who may not act for approval by himself. In such cases, an advocate may be assigned to approve or verify the data on behalf of the patient. The patient advocate may approve the aggregated data in such embodiments and a patient advocate approval may be processed instead of a direct patient approval processing. For example, a parent of a child may be considered as a patient advocate in some cases.

In an example, the embodiments herein may allow processing a healthcare professional approval. The healthcare professional approval signifies one or more of accuracy of the PGHD, reliability of the PGHD, completeness of the PGHD, and defines a person responsible for accuracy and completeness of the PGHD who may be either the patient, a relative of the patient, the healthcare professional, or any other person or firm. The subsequent approval by the healthcare professional after the patient approval facilitates in providing an increased degree of trust and reliability of the PGHD for assisting in clinical workflow during clinical decision making. The multi-level approval by the patient himself and subsequently by the authorized healthcare professional is maintained in the electronic medical transactional system 116 with a reliability index determined based on the approval from the healthcare professional and/or the patient. The reliability index is indicative of a degree of accuracy and completeness and trustworthiness of the PGHD aggregated from the plurality of computing machines 104a-c.

In an example, the reliability index of the PGHD may be determined before integration of the PGHD into the electronic medical transactional system 116. If the PGHD is identified to be verified by the patient (Yes), then a first trust score is associated with the aggregated PGHD. Otherwise, if the PGHD is identified to be not verified by the patient (No), then a second trust score is associated with the aggregated PGHD. The second trust score is different from the first trust score. In an example, based on the patient input through one of the approval options signifying verification status, the processing circuit may associate a numerical trust score with each of the new verified computer executable patient data files.

Subsequently, it may be determined whether the aggregated PGHD is approved by a healthcare professional. If the PGHD is identified to be verified by the healthcare professional (Yes), then a third trust score is associated with the aggregated PGHD. Otherwise, if the aggregated PGHD is identified to be not approved by the healthcare professional (No), then a fourth trust score is associated with the PGHD. The fourth trust score is different from the third trust score. In some embodiments, the patient may be a child or any other person who may not act for verification by himself. In such cases, an advocate may be assigned to verify the PGHD or a computer executable patient data file on behalf of the patient. The patient advocate may verify the aggregated data in such embodiments and patient advocate verification may be processed instead of a direct patient verification processing. For example, a parent of a child may be considered as a patient advocate in some cases. Based on whether an advocate is needed or not, the verification may be requested by the patient or by his advocate.

The PGHD may be associated with a cumulative score based on identified scores form among the first trust score, second trust score, third trust score, and the fourth trust score to generate the reliability index for the PGHD. For example, if the PGHD or any of the unverified computer executable patient data files is verified by the patient as well as the healthcare professional, then the cumulative score associated with the PGHD or the unverified computer executable patient data file is defined based on the first trust score and the second trust score. If the PGHD is approved by the patient but not by the healthcare professional, then the cumulative score is defined based on the first trust score and the fourth trust score. If the PGHD is approved by the healthcare professional and not by the patient, then the cumulative score is defined based on the second trust score and the third score. If the PGHD is approved by neither of the patient and the healthcare professional, then the cumulative score is defined based on the second trust score and the fourth trust score.

With the use of the reliability index and the cumulative scores associated with the PGHD and the multi-level verifications/approvals of the PGHD, the accuracy, completeness, and validity of the multi-sourced PGHD may be assessed. Based on the assessment, appropriate and accurate clinical decisions can be made.

The PGHD may be pushed into the electronic medical transactional system 116 which may be accessed by other parties associated with the plurality of computing stations 112. In accordance with various embodiments herein, the PGHD gathered from the plurality of computing machines 104a-c may be verified for accuracy and therefore the clinicians or healthcare professionals or other parties accessing the PGHD through the electronic medical transactional system 116 can identify which portions of the PGHD are accurate and which are not and accordingly use the accurate and verified portions of the PGHD for clinical decisions and patients' healthcare management solutions.

The communications transmitter 120 may be configured to receive requests for accessing the PGHD by a party authorized to access the electronic medical transactional system 116 and/or send output data to the party in response to the access. The communications transmitter 116 may be enabled through a communication channel including a wired or a wireless or both communication mediums.

The embodiments herein may facilitate multi-source unverified patient generated healthcare data collection and integration within the electronic medical transactional system 116. The embodiments herein may further allow processing of validity and approval of the unverified patient generated healthcare data files so as to promote reliable clinical decision making. The multi-level approval techniques and systems ensure high clinical reliability and validity. The systems and methods provided by the embodiments herein allow verification and approval of the PGHD.

In some embodiments, authorized parties may be notified by the electronic medical transactional system 116 of the aggregated and verified PGHD so that the authorized parties can access portions of the PGHD for use in clinical workflows with sufficient level of trust and confidence. Notifications may be sent on a periodic basis or when there is an update in the electronic medical transactional system 116. In an embodiment, patients who are respective owners of the PGHD may also be informed through notifications about access of the PGHD by the authorized parties or about requests for authorizations by unauthorized parties for seeking patient approval(s) of access to the PGHD.

In some embodiments, when the PGHD is pushed into the electronic medical transactional system 116, it may also include details about who is authorized to view the PGHD. A patient may allow an authorized party to further authorize access to more persons or entities based on defined conditions. For example, a healthcare professional authorized to access PGHD by a patient may be allowed by the patient to further share the data with a neurologist whom the healthcare professional needs to consult for diagnosis. An interface (not shown) may be provided to share the data to more persons or parties. In some embodiments, customized actions and reactions may be defined by setting defined rules for facilitating implementation of behavioral patterns through specific triggers.

In an example, the embodiments herein allow one to discover anomalies in the PGHD such that someone in an entire health supply chain does not make a wrong decision utilizing the wrong PGHD through the electronic medical transactional system 116. The embodiments herein allow increasing and/or identifying reliability of the PGHD through associated scores based on who has verified the PGHD. The embodiments herein enable a patient to intervene in data management process of the electronic medical transactional system 116 thereby improving reliability and trustworthiness of the PGHD. Thus, the electronic medical transactional system 116 may confirm to others using the PGHD as to how much the PGHD can be trusted for various end purposes.

In accordance with various embodiments, the electronic medical transactional system 116 is designed to include patient-centric features so as to address patient verification challenges that remain missing if the PGHD utilized through the electronic medical transactional system 116 is not verified by the patient. The electronic medical transactional system 116 not only is networked to the healthcare provider but also to the patient directly and indirectly through other servers in different embodiments. The embodiments herein provide a facility to let the patient intervene for confirmation of or dispute with the PGHD used by the electronic medical transactional system 116. The electronic medical transactional system 116 may employ a plurality of patient-centric applications to facilitate interaction with patients. An exemplary electronic medical transactional system 116 is shown in FIG. 3, with reference to FIGS. 1 through 2. The electronic medical transactional system 116 is networked with the cloud gateway agent server 102 as well as the plurality of computing stations 112 for access of the PGHD contained in the computer executable patient data files. The electronic medical transactional system 116 may include or coupled with the communications transmitter 120. The communications transmitter 120 may facilitate transmitting of the data messages as discussed above as well as transmission and receipt of the verified computer executable patient data files and the new patient verified computer executable patient data files from the cloud gateway agent server 102. The electronic medical transactional system 116 may further include a rules repository 302 to store verification rules that define standard guidelines for accepting and/or rejecting the computer executable patient data files based on a trust score associated with the computer executable patient data files received from the cloud gateway agent server 102. The electronic medical transactional system 116 may further include a filter circuit 304 capable of automatically separating a computer executable patient data file that does not meet criteria as defined by the verification rules and rejects the computer executable patient data file from being pushed into the electronic medical transactional system 116 if the trust score associated with the computer executable patient data file is below a threshold limit. The electronic medical transactional system 116 may include the data storage device 306 for storing the PGHD in the form of computer executable patient data files. The electronic medical transactional system 116 may include a processor 308 for executing programmed instructions associated with the electronic medical transactional system 116. The electronic medical transactional system 116 may include an interface unit 310 capable of providing an interface for communication between the electronic medical transactional system 116 and the cloud gateway agent server 102.

The electronic medical transactional system 116 further includes an Electronic Medical Record (EMR) data server 312. Among other tasks, the EMR data server 312 in association with the processor 308 and social networking applications 314 may be configured to execute programmed instructions for enabling social linkages with various entities such as patients, healthcare providers and financial entities through a socially aware network or social networking platform. The social networking applications 314 may allow for storing and creating medical records, and authorizing access to a third party computer such as the computing station 112 to the medical records through the social networking platform with dynamically changing connections wherein, the third party computer is associated with the social networking platform as a dynamically changing connection. A patient computer or a third party computer may also be associated as a dynamically changing connection with the social networking platform. The computing station 112 may be communicatively connected to the electronic medical transactional system 116 through the social networking platform as a dynamically changing connection and the EMR data server 312 may serve as a component of the social networking platform. The social networking platform herein may refer to a socially networked engine or portal allowing access to a crowd of persons or computers as network connections whose identity and profile and social relationships among one another changes dynamically over time. These dynamically changing connections may access the electronic medical transactional system 116 through registered social profiles. The social networking platform may allow users (who are registered as dynamic connections) to sign up and communicate with their friends, peers, colleagues, coworkers or other individuals they share some common interest with. These connections are made through requests and most commonly must be mutually accepted before certain functionality is allowed between two or more individuals. The connections provide the ability to the users to share content amongst and between them through the electronic medical transactional system 116 enabled through the social networking applications 314.

In an example, the electronic medical transactional system 116 may be deployed as a social networking server for medical data interactions and PGHD exchange with the computing stations 112 through social profiles of various entities associated with the computing stations 112. The social networking applications 314 may be enabled through a social networking module 316 which supports standard social networking operations such as hosting of social profiles and/or accessing of social profiles of the various entities, and facilitating communication among the entities through the electronic medical transactional system 116 as a social networking server. The entities may request to access the PGHD. In return, the electronic medical transactional system 116 may generate and supply to the entities an entity-controlled social profile. The entity-controlled social profile page may include a web link that may redirect a computing station such as 118 to the requested PGHD or requested computer executable patient data file. In accordance with this embodiment, the PGHD may be accessed through the social networking platform as the social networking platform is networked to the electronic medical transactional system 116 and/or deployed through the electronic medical transactional system 116.

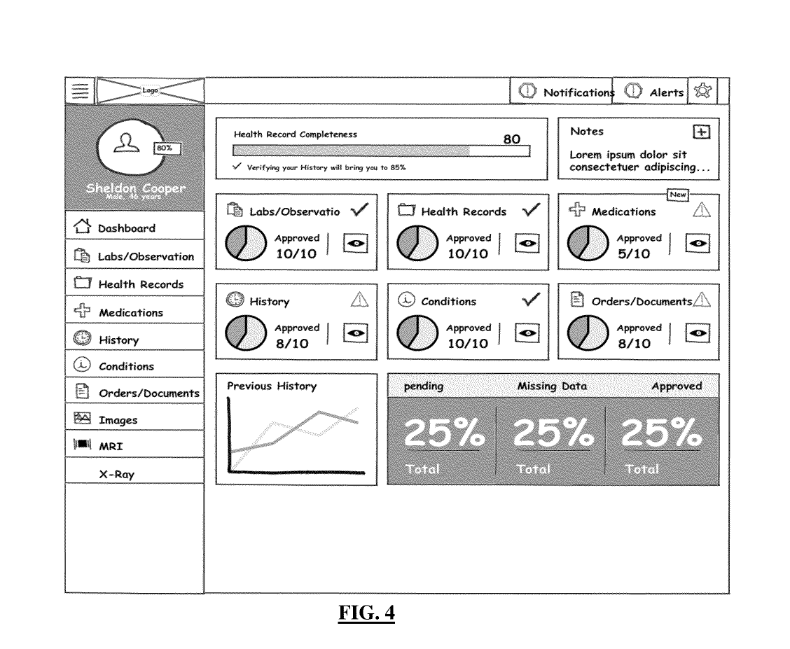

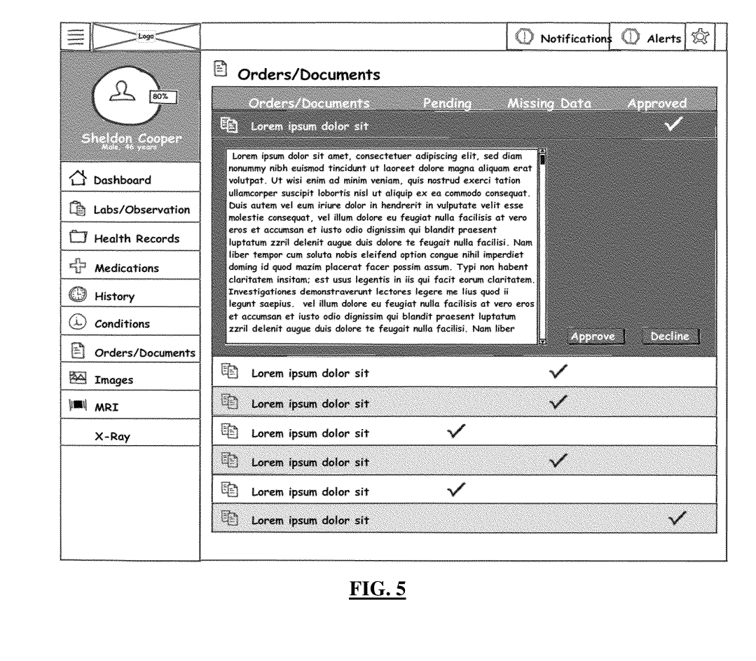

FIG. 4, with reference to FIGS. 1 through 3, illustrates a user interface 400 for a patient presented to the display unit 114 upon launching of the gateway application 124a. The data object transmitted from the cloud gateway agent server 102 may enable presenting of the query statements and the verification options or approval options to the patient as depicted in the exemplary user interface 400. The patient may receive notification and alerts about new unverified computer executable patient data files aggregated by the cloud gateway agent server 102. The status of the plurality of computer executable patient data files may be reflected under different classes such as labs related, health records, medications, and the like. The data object may also reflect number of patient data files that are verified/approved, that are unverified/pending for verification and that are missing or incomplete etc. As shown in FIG. 5, with reference to FIGS. 1 through 4, a new user interface 401 may be presented to the patient upon selection of a particular unverified computer executable patient data file. The patient can review text embedded in the unverified computer executable patient data file and through a single-click option may either decline the unverified computer executable patient data file indicating that data contained therein is wrong or may accept it indicating that the data contained is verified by the patient.

As shown in FIGS. 4 and 5, the user interfaces 400, 401 may provide an integrated view of the unverified computer executable patient data files such that the patient may find entire unverified PGHD at a single place in a structured manner and the patient may have to merely select a particular data file and either verify the PGHD contained therein or dispute it by a single clickable approval option. The patient may review from a single screen all the unverified computer executable patient data files and locate sources from where the PGHD contained in the different computer executable patient files are derived. The data object transmitted from the cloud gateway agent server may define the unverified PGHD in a structured and unified manner before being presented to the computing machine 104a.

In an example, the data object may contain the query statements such as whether the data is correct or not, whether the data is complete or not, whether the specific physiological conditions mentioned in a computer executable patient data file are correct or not, and the like. The data object may also include a plurality of single-clickable approval options as discussed above. The data object may also contain embedded digital text-based notes for presentation to the patient on the user interface upon launch of the gateway application 124a.

In an example, the cloud gateway agent server 102 may manage PGHD overload by for example classifying the PGHD into solicited and unsolicited information based on instructions from clinicians, healthcare providers or from other entities that use the PGHD through the electronic medical transactional system 116. The cloud gateway agent server 102 may prioritize review of the PGHD by patients in accordance with whether the PGHD contains the solicited information or the unsolicited information. The solicited information may include information requested by a computing station such as the computing station 118 associated with an entity for use and as such may be prioritized for patients review by the cloud gateway agent server 102. The unsolicited information on the contrary may not have been demanded or requested by an entity and accordingly review of the unsolicited information may be delayed. The entities may send a request to the electronic medical transactional system 116 about what they need and accordingly the electronic medical transactional system 116 may communicate this to the cloud gateway agent server 102 and the cloud gateway agent server 102 may accordingly classify the PGHD and prioritize the review for the solicited information. The entities may determine what type of data may be useful to them in informing diagnosis and treatment decisions and the cloud gateway agent server 102 may prioritize the review based on what is determined to be useful by the entities associated with the computing stations 118.

The embodiments herein may be embodied as a computer program product configured to include a pre-configured set of instructions, which when performed, can result in actions as stated in conjunction with the methods described above. In an example, the pre-configured set of instructions can be stored on a tangible non-transitory computer readable medium or a program storage device. In an example, the tangible non-transitory computer readable medium can be configured to include the set of instructions, which when performed by a device, can cause the device to perform acts similar to the ones described here. Embodiments herein may also include tangible and/or non-transitory computer-readable storage media for carrying or having computer executable instructions or data structures stored thereon. Such non-transitory computer readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer executable instructions, associated data structures, and program modules represent examples of the program code means for executing steps of the methods disclosed herein. The particular sequence of such executable instructions or associated data structures represents examples of corresponding acts for implementing the functions described in such steps.

The techniques provided by the embodiments herein may be implemented on an integrated circuit chip (not shown). The chip design is created in a graphical computer programming language, and stored in a computer storage medium (such as a disk, tape, physical hard drive, or virtual hard drive such as in a storage access network). If the designer does not fabricate chips or the photolithographic masks used to fabricate chips, the designer transmits the resulting design by physical means (e.g., by providing a copy of the storage medium storing the design) or electronically (e.g., through the Internet) to such entities, directly or indirectly. The stored design is then converted into the appropriate format (e.g., GDSII) for the fabrication of photolithographic masks, which typically include multiple copies of the chip design in question that are to be formed on a wafer. The photolithographic masks are utilized to define areas of the wafer (and/or the layers thereon) to be etched or otherwise processed.

The resulting integrated circuit chips can be distributed by the fabricator in raw wafer form (that is, as a single wafer that has multiple unpackaged chips), as a bare die, or in a packaged form. In the latter case the chip is mounted in a single chip package (such as a plastic carrier, with leads that are affixed to a motherboard or other higher level carrier) or in a multichip package (such as a ceramic carrier that has either or both surface interconnections or buried interconnections). In any case the chip is then integrated with other chips, discrete circuit elements, and/or other signal processing devices as part of either (a) an intermediate product, such as a motherboard, or (b) an end product. The end product can be any product that includes integrated circuit chips, ranging from toys and other low-end applications to advanced computer products having a display, a keyboard or other input device, and a central processor. In one embodiment, the end product comprises a kiosk that includes the interfaces 400, 401 of FIGS. 4 and 5, or accesses the various other hardware and software components described herein.

The embodiments herein can include both hardware and software elements. The embodiments that are implemented in software include but are not limited to, firmware, resident software, microcode, etc.

Furthermore, the embodiments herein can take the form of a computer program product accessible from a computer-usable or computer-readable medium providing program code for use by or in connection with a computer or any instruction execution system. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output (I/O) devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

A representative hardware environment for practicing the embodiments herein is depicted in FIG. 6, with reference to FIGS. 1 through 5. This schematic drawing illustrates a hardware configuration of an information handling/computer system 500 in accordance with the embodiments herein. The system 500 comprises at least one processor or central processing unit (CPU) 10. The CPUs 10 are interconnected via system bus 12 to various devices such as a random access memory (RAM) 14, read-only memory (ROM) 16, and an input/output (I/O) adapter 18. The I/O adapter 18 can connect to peripheral devices, such as disk units 11 and tape drives 13, or other program storage devices that are readable by the system. The system can read the inventive instructions on the program storage devices and follow these instructions to execute the methodology of the embodiments herein. The system further includes a user interface adapter 19 that connects a keyboard 15, mouse 17, speaker 24, microphone 22, and/or other user interface devices such as a touch screen device (not shown) to the bus 12 to gather user input. Additionally, a communication adapter 20 connects the bus 12 to a data processing network 25, and a display adapter 21 connects the bus 12 to a display device 23 which may be embodied as an output device such as a monitor, printer, transmitter, or interfaces 400, 401 (of FIGS. 4 and 5), for example.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

What is claimed is:

1. A system comprising:
a cloud gateway agent server that receives and aggregates patient generated healthcare data associated with a patient and acquired without patient intervention from a plurality of computing machines located separately, wherein said patient generated healthcare data comprises a plurality of computer executable patient data files residing in said plurality of computing machines;
a medical record repository database communicatively coupled with said cloud gateway agent server and stores said plurality of computer executable patient data files and metadata associated with said plurality of computer executable patient data files;
a processing circuit that:
performs natural language processing and metadata analysis of said plurality of computer executable patient data files to identify patient verified computer executable patient data files and patient unverified computer executable patient data files from among said plurality of computer executable patient data files;
generates a data object including a plurality of query statements and approval options corresponding to each of said unverified computer executable patient data files;
transmits said data object to an external computing machine at said patient along with said unverified computer executable patient data files outputted on a remotely located display unit connected operatively with said external computing machine through an automatically generated notification by said processing circuit, wherein said data object represents an integrated view of said patient generated healthcare data residing on said plurality of computing machines; and
updates said unverified computer executable patient data files as new verified computer executable patient data files in said medical record repository database based on an input received from said external computing machine signifying verification of said unverified computer executable patient data files by said patient;
a rules engine communicatively coupled with said processing circuit and that executes a set of programmable rules including dictionary references, and patient verification references to govern patient approval, said metadata analysis and said natural language processing;
an electronic medical transactional system communicatively coupled with said medical record repository database and said processing circuit through said cloud gateway agent server and retrieves and stores said patient verified computer executable patient data files and said new verified computer executable patient data files from said medical records repository database; and communicates medical data messages among a plurality of computer stations located at patients, healthcare providers, and financial entities, wherein said medical data messages are obtained from said patient verified computer executable patient data files and said new verified computer executable patient data files; and
a communications transmitter coupled with said electronic medical transactional system that transmits said medical data messages to said plurality of computer stations identified by a patient approval.

2. The system of claim 1, wherein at least one machine from among said plurality of computing machines comprises a smart wearable medical device.

3. The system of claim 1, wherein at least a portion of said patient generated healthcare data contained in at least one of said plurality of computer executable patient data files is obtained by said cloud gateway agent server from a computing machine other than at said patient.

4. The system of claim 3, wherein said at least a portion of said patient generated healthcare data is obtained from said computing machine at a healthcare service provider of said patient.

5. The system of claim 1, wherein each of said plurality of computing machines are operatively coupled with an extensible agent appliance that launches a gateway application configured to pair said plurality of computing machines with said cloud agent server to allow access of said plurality of computer executable patient data files residing on said plurality of computing machines by said cloud agent server.

6. The system of claim 5, wherein said cloud agent server installs said gateway application remotely on said plurality of computing machines through said extensible agent appliance.

7. The system of claim 5, wherein said gateway application is launched at said external computing machine associated with said patient to allow said patient to view sources of said unverified computer executable patient data files and to verify said unverified computer executable patient data files through a single-clickable user executable response against one of said approval options.

8. The system of claim 1, wherein said processing circuit homogenizes said patient generated healthcare data contained in said computer executable patient data files in a defined Health Insurance Portability and Accountability Act (HIPAA) compliant format.

9. The system of claim 1, wherein, based on said patient input signifying said verification, said processing circuit associates a numerical trust score with each of said new verified computer executable patient data files.

10. The system of claim 9, wherein said electronic medical transactional system comprises a filter circuit such that said filter circuit rejects said plurality of computer executable patient data files from being pushed into said electronic medical transactional system if said trust score associated with said plurality of computer executable patient data files is below a threshold limit.

11. The system of claim 1, wherein said electronic medical transactional system further comprises a social networking application that dynamically changes social networking connections to interact with said electronic medical transactional system for accessing said verified computer executable patient data files.

12. The system of claim 1, wherein said processing circuit performs natural language processing on an embedded patient natural language text note contained digitally in said plurality of computer executable patient data files.

13. The system of claim 1, wherein said processing circuit determines verification patterns by said patient and automatically verify said unverified computer executable patient data files based on said verification patterns.

14. A computer-implemented method for use in an electronic medical transactional system, said computer-implemented method comprising:
aggregating patient generated healthcare data associated with a patient from a plurality of computing machines located separately by a cloud gateway agent server over a network through a communication circuit without patient intervention, wherein said patient generated healthcare data comprises a plurality of computer executable patient data files residing on said plurality of computing machines;
storing said plurality of computer executable patient data files in a medical record repository database communicatively coupled with said cloud gateway agent server;
storing metadata associated with said plurality of computer executable patient data files in said medical record repository database;
performing natural language processing and metadata analysis of said plurality of computer executable patient data files by a processing circuit communicatively coupled with said cloud gateway agent server to identify patient verified computer executable patient data files and patient unverified computer executable patient data files from among said plurality of computer executable patent data files;
generating, by said processing circuit, a data object including a plurality of query statements and approval options corresponding to each of said unverified computer executable patient data files;
presenting said data object along with said unverified computer executable patient data files on a remotely located display unit accessible by said patient through an automatically generated notification by said processing circuit, wherein said data object represents an integrated view of said patient generated healthcare data residing on said plurality of computing machines;
receiving an input against each of said plurality of query statements corresponding to said unverified computer executable patient data files by said patient;
updating said unverified computer executable patient data files as new verified computer executable patient data files in said medical records repository database based on said received input;
pushing said verified computer executable patient data files and said new verified computer executable patient data files into said electronic medical transactional system; and
communicating, by said electronic medical transactional system, medical data messages among a plurality of computer stations located at patients, healthcare providers, and financial entities, wherein said medical data messages are obtained from said patient verified computer executable patient data files and said new verified computer executable patient data files based on a predefined patient approval associated with said medical data messages.

15. The method of claim 14, further comprising associating a trust score and a reliability index determined based on said trust score with each of said plurality of computer executable patient data files based on a status of verification and status of completeness of said plurality of computer executable patient data files.

16. A non-transitory program storage device readable by a computer, and comprising a program of instructions executable by said computer for use in an electronic medical transactional system to perform a method, said method comprising:
aggregating patient generated healthcare data associated with a patient from a plurality of computing machines located separately by a cloud gateway agent server over a network through a communication circuit without patient intervention, wherein said patient generated healthcare data comprises a plurality of computer executable patient data files residing on said plurality of computing machines;
storing the plurality of computer executable patient data files in a medical record repository database communicatively coupled with said cloud gateway agent server;
storing metadata associated with said plurality of computer executable patient data files in said medical record repository database;
performing natural language processing and metadata analysis of said plurality of computer executable patient data files by a processing circuit communicatively coupled with said cloud gateway agent server to identify patient verified computer executable patient data files and patient unverified computer executable patient data files from among said plurality of computer executable patent data files;
generating, by said processing circuit, a data object including a plurality of query statements and approval options corresponding to each of said unverified computer executable patient data files;
presenting said data object along with said unverified computer executable patient data files on a remotely located display unit accessible by said patient through an automatically generated notification by said processing circuit, wherein said data object represents an integrated view of said patient generated healthcare data residing on said plurality of computing machines;
receiving an input against each of said plurality of query statements corresponding to said unverified computer executable patient data files by said patient; and
updating said unverified computer executable patient data files as new verified computer executable patient data files in said medical records repository database based on said received input;
pushing said verified computer executable patient data files and said new verified computer executable patient data files into said electronic medical transactional system; and
communicating, by said electronic medical transactional system, medical data messages among a plurality of computer stations located at patients, healthcare providers, and financial entities, wherein said medical data messages are obtained from said patient verified computer executable patient data files and said new verified computer executable patient data files based on a predefined patient approval associated with said medical data messages.

17. The non-transitory program storage device of claim 16, wherein said method further comprises associating a trust score and a reliability index determined based on said trust score with each of said plurality of computer executable patient data files based on a status of verification and status of completeness of said plurality of computer executable patient data files.
